(19) United States
(12) Patent Application Publication
(10) Pub. No.: US 2018/0184392 A1
(43) Pub. Date: Jun. 28, 2018

(54) ADDING POSITION AND AOA INFORMATION TO FTM PROCEDURE

(71) Applicant: INTEL IP CORPORATION, SANTA CLARA, CA (US)

(72) Inventor: Gaby PRECHNER, Rishon Lezion (IL)

(21) Appl. No.: 15/388,523

(22) Filed: Dec. 22, 2016

(51) Int. Cl. H04W 64/00; H04W 24/08; H04L 12/26

(52) U.S. Cl. CPC H04W 64/00; H04W 84/12; H04L 43/0858; H04W 24/08

(57) ABSTRACT

The devices and methods herein provide enhanced FTM positioning. A responding STA can provide enhanced measurement capabilities that the initiating STA (a mobile terminal or mobile wireless device) does not have. These enhanced measurement capabilities can be leveraged to provide better positioning information to the initiating STA. The new measurement capabilities can include, but are not limited to, providing a measurement of AoA (Angle of Arrival) derived from the responding STA's larger antenna array, and/or providing measurements by several APs in a managed network.

### TECHNICAL FIELD

An exemplary aspect is directed toward communications systems. More specifically an exemplary aspect is directed toward wireless communications systems and even more specifically to IEEE (Institute of Electrical and Electronics Engineers) 802.11 wireless communications systems. Even more specifically, exemplary aspects are at least directed toward one or more of IEEE (Institute of Electrical and Electronics Engineers) 802.11n/ac/ax/ . . . communications systems and in general any wireless communications system or protocol, such as 4G, 4G LTE, 5G and later, and the like.

### BACKGROUND

Wireless networks transmit and receive information utilizing varying techniques and protocols. For example, but not by way of limitation, common and widely adopted techniques used for communication are those that adhere to the Institute for Electronic and Electrical Engineers (IEEE) 802.11 standards such as the IEEE 802.11n standard, the IEEE 802.11ac standard, the IEEE 802.11ax standard, the IEEE 802.11 RevMC, and/or other present or future IEEE 802.11 standards.

One function of wireless devices is determining position. While outside, wireless devices can use a Global Positioning Satellite (GPS) signal to determine position. However, while indoors, wireless devices often cannot receive the GPS signal and, thus, cannot determine the position of the wireless device. Some wireless systems allow for gross measurement of location using a feature called WiFi Fine-Time-Measurement (FTM) or Time-Of-Flight (ToF).

The methods introduced in the IEEE 802.11 perform a time-based range measurement that estimates the distance a wireless device is from an access point (AP) or other device. The time measurement is a round trip time measurement (RTT) (also called, the ToF) for a signal sent from the wireless device to the AP and back to the wireless device. Generally, the device receiving the ToF signal will be an infrastructure entity, i.e., an AP or FTM responder. Currently, FTM or ToF supports only the transmission of time of arrival (ToA) and time of departure (ToD) and does not support providing the initiating STA additional information. As such, the position measurements are less accurate, and the measurement method is inefficient.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an embodiment of an environment using an enhanced FTM procedure;

FIG. 2 illustrates an embodiment of a signalling process for enhanced FTM;

FIG. 3A illustrates an embodiment of a data structure sent, received, and/or stored during the enhanced FTM process;

FIG. 3B illustrates an embodiment of a data structure sent, received, and/or stored during the enhanced FTM process;

FIG. 3C illustrates an embodiment of a data structure sent, received, and/or stored during the enhanced FTM process;

FIG. 3D illustrates an embodiment of a data structure sent, received, and/or stored during the enhanced FTM process;

FIG. 4 illustrates an embodiment of a procedure for enhanced FTM from the perspective of a responding station (STA);

FIG. 5 illustrates an embodiment of a procedure for enhanced FTM from the perspective of an initiating STA;

FIG. 6 illustrates an embodiment of a procedure for enhanced FTM from the perspective of a secondary STA;

FIG. 7 illustrates an embodiment of a procedure for enhanced FTM from the perspective of a position server;

FIG. 8 is an illustration of the hardware/software associated with a STA, a position server, a wireless device, and/or AP.

### DESCRIPTION OF EMBODIMENTS

The embodiments presented herein provide devices, methods, data structures, etc. for providing enhanced FTM positioning. Generally, a responding STA can provide enhanced measurement capabilities that the initiating STA (a mobile terminal or mobile wireless device) does not have. These enhanced measurement capabilities can be leveraged to provide better positioning information to the initiating STA. This disclosure proposes to add the capability for the responding STA to provide the initiating STA additional measurement information that can increase accuracy and efficiency in the positioning computation of the initiating STA.

The new measurement capabilities can include one or more of, but are not limited to:

1. Measurement of AoA (Angle of Arrival) derived from the responding STA's larger antenna array;
2. Measurement by several STAs in a managed network. For example, APs can calculate the device position (for the initiating STA) with the aid of neighbor APs using multiple positioning technics (e.g., trilateration of Received Signal Strength Indicator (RSSI), triangulation of AoA, Time Difference of Arrival (TDOA), etc.).

If the responding STA has the capability of AoA and/or improved positioning measurement, the responding STA can send the new information to the initiating STA as part of the FTM procedure (in addition to the ToA and ToD parameters). Further, the responding STA may publish the new capabilities as part of the capabilities portion published in the wireless beacon. The new capabilities may also be published in other messages, for example, the neighbor report.

Currently, a responding STA provides the initiating STA with the ToA and ToD that the responding STA measured so the initiating STA can compute the range from the responding STA. There is currently no method to provide the initiating STA additional positioning information even if the responding STA may have made such measurements. The embodiments herein provide such additional measurements of the responder STA, e.g., Angle of Arrival, to the initiating STA to improve significantly the efficiency and accuracy of the initiating STA's positioning capabilities.

The improvement in accuracy and efficiency comes from the fact that the initiating STA can now compute the location of the initiating STA only with the measurements from one signal, rather than the at least three signals needed previously, that is, range and angle can be used for full positioning computation. The extra information can be used to incorporate the additional measurements into the initiating STA's positioning engine achieving higher accuracy and reliability of the positioning.

Some embodiments may involve wireless communications according to one or more other wireless communication standards. Examples of other wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, IEEE 802.11 ah, IEEE 802.11ay, and/or other present of future IEEE 802.11 standard, Wi-Fi Alliance (WFA) wireless communication standards, such as, Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above.

Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

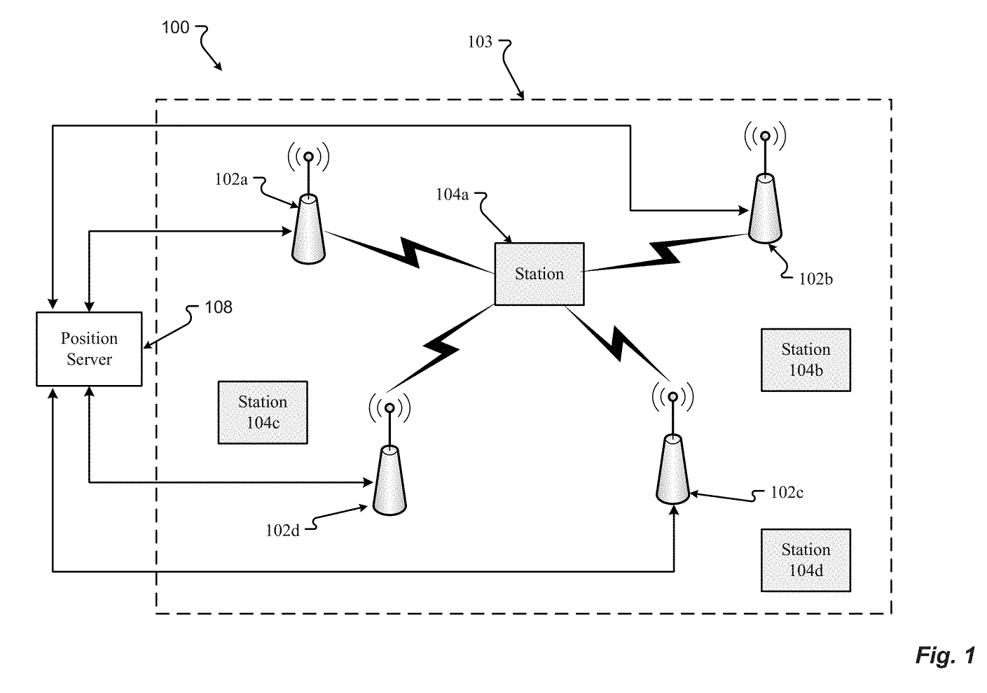

FIG. 1 illustrates an example of an operating environment 100 which may be representative of various configurations described herein. The WLAN 103 may comprise a basic service set (BSS) that may include a master station 102 and one or more other stations (STAs) 104. Generally, the master station 102 can function as the responding STA, while the other STA 104 is the initiating STA (however, in some configurations, these roles may be reversed).

The master station 102 may be an AP using the IEEE 802.11 standards to transmit and receive. Hereinafter, the term AP will be used to identify the master station 102. The AP 102 may be a base station and may use other communications protocols, as well as the IEEE 802.11 protocol. The IEEE 802.11 protocol may be the IEEE 802.11ax or later standard. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). The AP 102 may have a large antenna array composed of two or more antenna that can make measurements on AoA, AoA error, etc.

The STAs 104 may include one or more high-efficiency wireless (HEW) (as illustrated in, e.g., the IEEE 802.11ax standard) STAs 104a, b, d and/or one or more legacy (as illustrated in, e.g., the IEEE 802.11n/ac standards) STAs 104c. The legacy STAs 104c may operate in accordance with one or more of IEEE 802.11 a/b/g/n/ac/ad/af/ah/aj, or another legacy wireless communication standard. The HEW STAs 104a, b, d may be wireless transmit and receive devices, for example, a cellular telephone, a smart telephone, a handheld wireless device, wireless glasses, a wireless watch, a wireless personal device, a tablet, or another device that may be transmitting and receiving using a IEEE 802.11 protocol, for example, the IEEE 802.11ax or another wireless protocol. In the operating environment 100, an AP 102 may generally manage access to the wireless medium in the WLAN 103.

Within the environment 100, one or more STAs 104a, 104b, 104c, 104d may associate and/or communication with the AP 102 to join the WLAN 103. Joining the WLAN 103 may enable STAs 104a-104d to wirelessly communicate with each other via the AP 102, with each other directly, with the AP 102, or to another network or resource through the AP 102. In some configurations, to send data to a recipient (e.g., STA 104a), a sending STA (e.g., STA 104b) may transmit an uplink (UL) physical layer convergence procedure (PLCP) protocol data unit (PPDU) comprising the data to AP 102, which may then send the data to the recipient STA 104a, in a downlink (DL) PPDU.

In some configurations, a frame of data transmitted between the STAs 104 or between a STA 104 and the AP 102 may be configurable. For example, a channel used in for communication may be divided into subchannels that may be 20 MHz, 40 MHz, or 80 MHz, 160 MHz, 320 MHz of contiguous bandwidth or an 80+80 MHz (160 MHz) of non-contiguous bandwidth. Further, the bandwidth of a subchannel may be incremented into 1 MHz, 1.25 MHz, 2.03 MHz, 2.5 MHz, 5 MHz and 10 MHz bandwidths, or a combination thereof, or another bandwidth division that is less or equal to the available bandwidth may also be used. The bandwidth of the subchannels may be based on a number of active subcarriers. The bandwidth of the subchannels can be multiples of 26 (e.g., 26, 52, 104, etc.) active subcarriers or tones that are spaced by 20 MHz. In some configurations, the bandwidth of the subchannels is 256 tones spaced by 20 MHz. In other configurations, the subchannels are a multiple of 26 tones or a multiple of 20 MHz. A 20 MHz subchannel may also comprise 256 tones for use with a 256 point Fast Fourier Transform (FFT).

At a given point in time, multiple STAs 104a-d, in the WLAN 103, may wish to send data. In some configurations, rather than scheduling medium access for STAs 104a-d in different respective UL time intervals, the AP 102 may schedule medium access for STAs 104a-d to support UL multi-user (MU) transmission techniques, according to which multiple STAs 104a-d may transmit UL MU PPDUs to the AP 102 simultaneously during a given UL time interval. For example, by using UL MU OFDMA techniques during a given UL time interval, multiple STAs 104a-d may transmit UL MU PPDUs to AP 102 via different respective OFDMA resource units (RUs) allocated by AP 102. In another example, by using UL MU multiple-input multiple-output (MU-MIMO) techniques during a given UL time interval, multiple STAs 104a-d may transmit UL MU PPDUs to the AP 102 via different respective spatial streams allocated by the AP 102.

To manage access, the AP 102 may transmit a HEW master-sync transmission, which may be a trigger frame (TF) or a control and schedule transmission, at the beginning of the control period. The AP 102 may transmit a time duration of the transmit opportunity (TxOP) and sub-channel information. During the HEW control period, HEW STAs 104a, b, d may communicate with the AP 102 in accordance with a non-contention based multiple access technique such as OFDMA or MU-MIMO. This HEW technique is unlike conventional WLAN communications in which devices communicate in accordance with a contention-based communication technique, rather than a multiple access technique. During the HEW control period, the AP 102 may communicate with stations 104 using one or more control frames, and the STAs 104 may operate on a sub-channel smaller than the operating range of the AP 102. Also, during the control period, legacy stations may refrain from communicating by entering a deferral period.

During the HEW master-sync transmission, the STAs 104 may contend for the wireless medium with the legacy devices 106 being excluded from contending for the wireless medium during the HEW master-sync transmission. The trigger frame used during this HEW master-sync transmission may indicate an UL-MU-MIMO and/or UL OFDMA control period. The multiple-access technique used during the control period may be a scheduled OFDMA technique, or alternatively, may be a TDMA technique, a frequency division multiple access (FDMA) technique, or a SDMA technique.

The AP 102 may also communicate with legacy stations and/or HEW stations 104 in accordance with legacy IEEE 802.11 communication techniques. In some configurations, the AP 102 may also be configurable to communicate with HEW stations 104 outside the HEW control period in accordance with legacy IEEE 802.11 communication techniques, although this is not a requirement.

STA 104a represents an initiating STA for conducting an enhanced FTM procedure in the WLAN 103. The initiating STA 104a may desire position information and can send a FTM request to begin an enhanced FTM procedure. Any of the APs 102 may act as the responding STA. For the purposes of explanation, AP 102a will be described as the responding STA with AP 102b being a secondary STA. Any or all of the other STAs 102b-102d can act as a secondary STA and can function as AP 102b does as a secondary STA, as described hereinafter.

The APs 102a-102d can have known positions by which the initiating STA 104a can determine its position. Each AP 102a-102d may be physically located at a distance from each other and from the initiating STA 104a, for example, at the four corners of a large room. The box 103 can represent the WLAN and also the physical room. With known positions in the room 103, the initiating STA 104a can determine its position in relation to one or more of the APs 102a-102d to determine its position in the room 103.

The position server 108 can be a computing function associated with the BSS formed by the APs 102a-102d. The computing function can be part of one of the APs 102a-102d, performed by a computing device locally located near or within the premises 103, and/or may be performed by a distant computing device that is remotely located and communicated with through and over a network, for example, a local area network, a wide area network, the Internet, etc. Each of the APs 102a-102d may communicate FTM information with the position server 108. The position server 108 may compile the information and return that information to the responding STA 102a or may use the information to determine or calculate a position for the initiating STA 104a. Thus, the position server 108 may send the position of the initiating STA 104a to the responding STA 102a to send to the initiating STA 104a. In the configurations herein, the position server 108 is optional but can function as a central, known location to send FTM information for the APs 102a-102d.

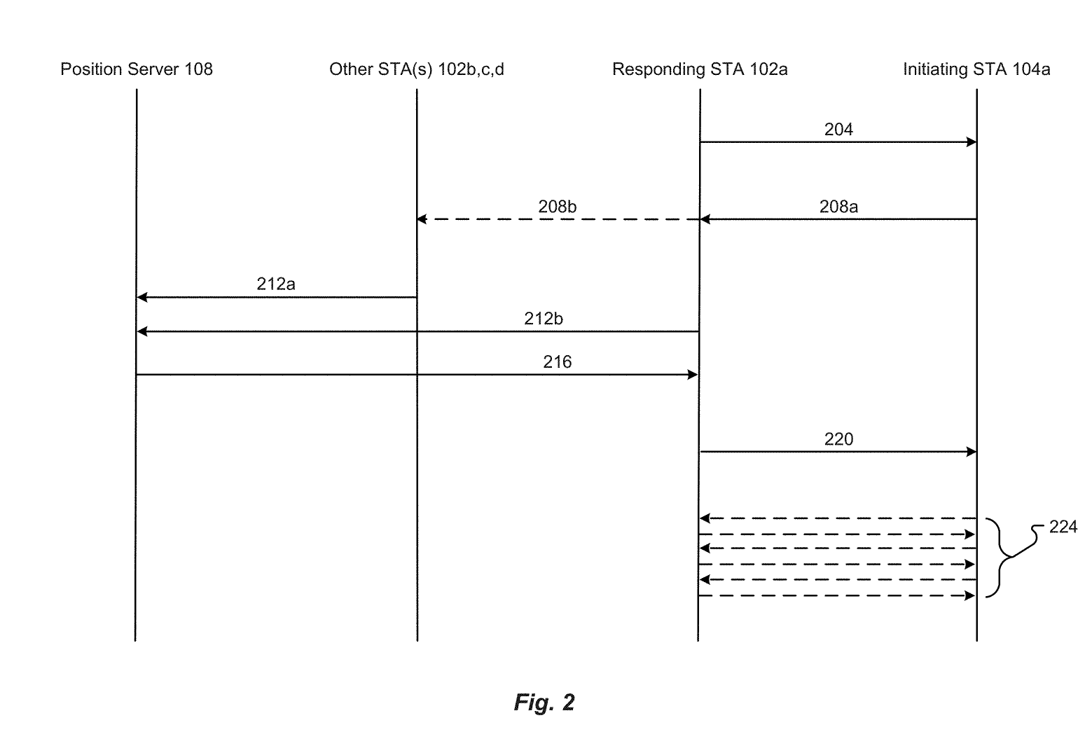

FIG. 2 illustrates the signalling process for the enhanced FTM procedure. In the simplified example in FIG. 2, STA 104a is the initiating STA and AP 102a is the responding STA. The two STAs perform the modified FTM procedure described herein, optionally with the other STAs 102b-102d and/or the position server 108. STAs 102b-102d can be considered additional responding STAs, where responding STA 102 does not perform the FTM procedure with the additional responding STAs 102b-102d, but the additional responding STAs 102b-102d do receive the FTM request signal from the initiating STA 104a (when the initiating STA 104a is performing the FTM procedure with the responding STA 102a) and can compute the RSSI, ToA and AoA of the FTM request signal.

All the information from all the additional responding STAs 102b-102d can be sent to a centric place (the position server 108) in which the position of the initiating STA 104a may be computed. The position server 108 can send the positioning information back to the responding STA 102a. In other configurations, as part of the modified FTM procedure, the additional responding STAs 102b-102d can receive the position information, computed by the position server 108 and sent from the position server 108, and send that position information directly to the initiating STA 104a.

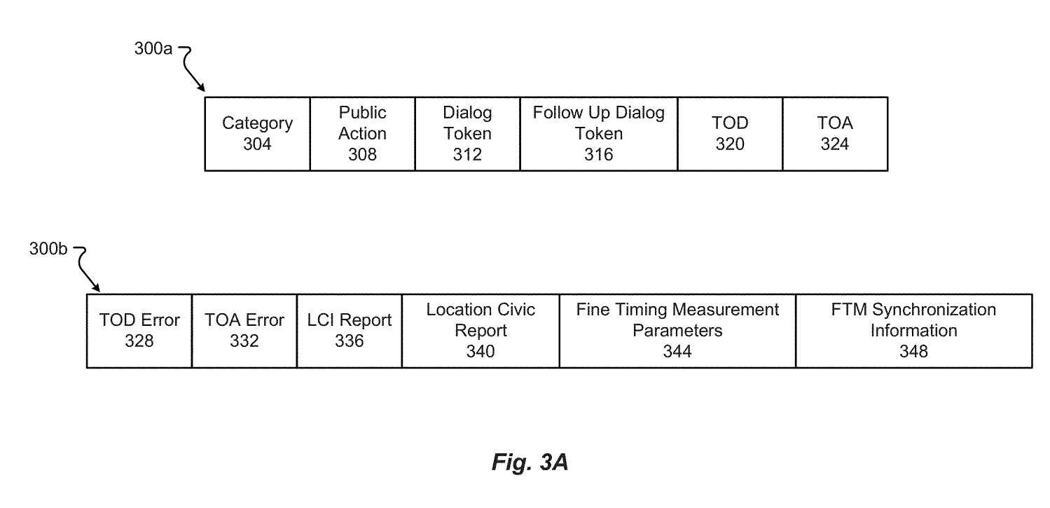

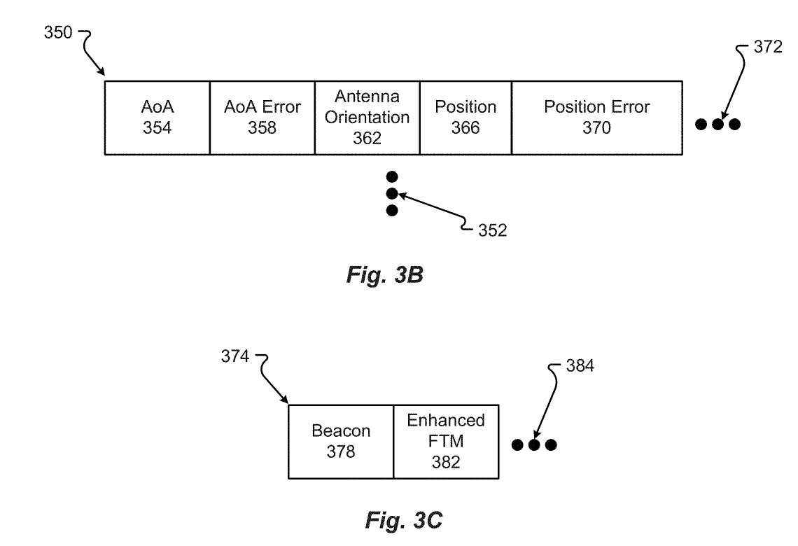

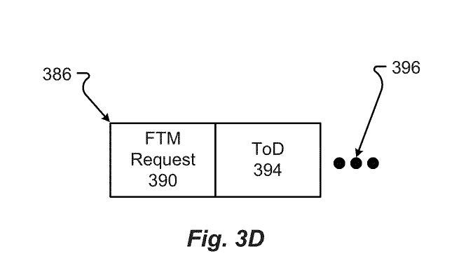

As shown in FIG. 2, one of the APs 102, for example, the responding STA 102a can send a beacon 204 that advertises the ability of that STA 102a to perform the enhanced FTM procedure. The initiating STA 104a can receive the beacon 204. The beacon 204 may be as described in conjunction with data structure 374 shown in FIG. 3C.

The initiating STA 104a may then send an FTM request signal 208a to the responding STA 102a. The FTM request signal 208a may also be received by the additional responding STAs 102b-102d as signal 208b. An example of the FTM request signal 208 may be described as data structure 386 shown in FIG. 3D.

In response to receiving the FTM request 208, the initiating STA 104a and, optionally, the additional responding STAs 102b-102d can send information on how the FTM request 208 was received, to a position server 108, as signals 212a and/or 212b. The received data can include enhanced FTM measurements including an angle of approach (AoA), an AoA error, an antenna orientation, a position of the STA 102a-102d, and/or a position error. The FTM data can also include a time of departure (ToD) and/or a time of arrival (ToA) for the FTM request. These data may be as described in conjunction with FIGS. 3A-3D. The position server 108 can compile the data, compute a position and/or conduct other functions associated with the received data. Thereinafter, the position server 108 may send a return signal 216 including the data, position, etc. back to the responding STA 102a.

The responding STA 102a may determine a position from the data and incorporate the position into an FTM response. In other configurations, the responding STA 104a compiles the data, without a determined position for the initiating STA 104a, into the FTM response. The FTM response signal 220 may then be sent back to the initiating STA 104a. The FTM response signal 220 can include the FTM response, which may include data structure(s) 300a, 300b, and/or 350 described in conjunction with FIGS. 3A-3C. The initiating STA 104a can receive the signal 220, extract the position, or use the data to compute a position.

If desired in some configurations, multiple instances 224 of the FTM request and response may be sent to better refine the signal, as shown in FIG. 2. Each interaction may more accurately determine the ToF of the signals and better estimate the range of the initiating STA 104a from the responding STA 102a or the additional responding STAs 102b-102d. This iteration of signals 224 can mimic the current FTM procedure or also provide enhanced measurement capabilities. In the current standard the responding STA 102a provides the initiating STA 104a the ToA and ToD that the responding STA 102a measured so the initiating STA 104a can compute the range from the responding STA 102a.

The procedure above provides additional measurements made by the responding STA 102a, for example, AoA, and the initiating STA's 104a positioning information can be sent back to the initiating STA 104a to improve significantly the efficiency and accuracy of the initiating STA's 104a positioning capabilities. The improvement in accuracy and efficiency comes from the fact that the initiating STA 104a can now accurately compute the location of the initiating STA 104a only with one FTM measurement (excluding iteration 224), instead of at least three measurements made in the current FTM procedure. Indeed, the range (ToF) and the AoA of the FTM request 208 can be used for a complete positioning computation. Alternatively, the extra information can be used to incorporate the additional measurements into the initiating STA's 104a positioning engine 822 to achieve higher accuracy and reliability of the positioning.

FIGS. 3A, 3B, 3C, and/or 3D include data structures or diagrams sent, received, and/or stored during the enhanced FTM procedure described herein. The embodiments presented in this disclosure suggest improving WiFi FTM based positioning accuracy and efficiency with additional measurement information sent from the responding STA 102a to the initiating STA 104a. To have such an improvement in accuracy and efficiency, more data is sent to the initiating STA 104a in the already-defined FTM Measurement action field (fields 344 and/or 348) sent from the responding STA 102a to the initiating STA 104a. The new data can include one or more of, but is not limited to: an AOA of the initiating STA's 104a packet transmission(s), including the FTM Request 208; the orientation of the responding STA's 102a antenna array relative to the north; and/or an estimated position of the initiating STA 104a as determined by the responding STA 102a or a position server 108.

As described above, the initiating STA 104a, using the additional information, can compute a position faster and/or more accurately. Further, the responding STA's 102a beacon can advertise the capability of the responding STA 102a to add the AoA and positioning capabilities to the FTM procedure.

Data structures 300a and 300b can represent an FTM report, similar to or provided in FTM response 220, sent from the responding STA 102a to the initiating STA 104a. The category 304 can define what type of content is in the message 300 (i.e., that the message 300 is an FTM report). The public action field 308 can indicate whether the message is meant for all STAs 104 or a specific STA. The dialog token 312 and follow up dialog token 316 can be identifiers for a specific message exchange between STAs 102, 104.

The ToD field 320 can include the time of departure for a previous message, i.e., the FTM request message 208. The ToD field 320 may include data provided in the FTM request message 208, for example, the ToD 394. The ToA field 324 can include the time of arrival at the responding STA 102a for a previous message, i.e., the FTM request message 208. The difference between the ToD 320 and ToA 324 is the ToF for the previous message and can be used to determine a range from the responding STA 102a to the initiating STA 104a (using known calculations based on the speed of light). The ToD error 328 and the ToA error 332 can include some measure of the inaccuracies in these measures based on time inaccuracies, latency, etc.

A Location Configuration Information (LCI) report 336 can provide information about the WLAN 103 and the BSS used in the WLAN 103, including known locations or how locations are defined. The location civic report 340 may provide information about location information, defined in CIVIC format, for the APs 102a-102d or other STA, possibly including the initiating STA 104a. The Fine Timing Measurement (FTM) Parameters 344 can include FTM information, such as the enhanced FTM measurements described in FIG. 3B. The FTM synchronization information 348 may also include enhanced FTM measurements or provide information on how to conduct FTM range measurements. Besides additions to the FTM Parameters 344 and/or FTM synchronization information 348, the above fields are described in various IEEE 802.11 specifications and need not be described in detail herein.

Enhanced FTM measurements 350, similar to or provided in FTM response 220, that may be provided as additional information in the FTM Parameters 344 and/or FTM synchronization information 348 may be as shown in FIG. 3B. There may be a set of enhanced FTM measurements 350 for each of the responding STA 102a and/or the additional responding STAs 102b-102d. While only one set of the enhanced FTM measurements 350 is shown in FIG. 3B more sets of the enhanced FTM measurements 350 may be included in the FTM response 220, as represented by ellipses 352. There may also be more or fewer measurements in the set of enhanced FTM measurements 350 than those shown in FIG. 3B, as represented by ellipses 372. The enhanced FTM measurements 350 can include one or more of, but is not limited to, an AoA 354, an AoA Error 358, an antenna orientation 362, a position 366, and/or a position error 370.

The AoA 354 can include the AoA measurement, which can be the determined direction of propagation of the radio-frequency wave (for a message, e.g., the FTM request 208) incident on the antenna array of the responding STA 102a. The AoA can determine the direction of propagation by measuring a phase difference of a signal at individual elements (each antenna) of the array (and possibly the position and/or orientation of each element) and, from these delays, the AoA can be calculated. AoA measurements can be made by measuring the difference in received phase at each element in the antenna array. In AoA, the delay of arrival at each element is measured directly and converted to an AoA measurement. The AoA 354 can be an angle provided in a three-dimensional space, which can include three separate angles (one for each dimension), a geodesic location, or other representation. The AoA error 358 is a determination of the accuracy of the AoA 354 based on timing and other inaccuracies. The AoA error 358 can be represented by a number of degrees error, a percentage error, etc.

The antenna orientation 362 can include a description of the configuration of the antenna array. The description can include data on how the antenna array is oriented with respect to magnetic or true north. In additional or alternative configurations, the antenna orientation 362 can include information about the number of antenna elements, the orientation of each antenna element, or other information.

The position 366 can include the location information for the responding STA 102a and/or an estimated position for the initiating STA 104a. The position 366 can correlate to or be based on information in the LCI report 336 and/or the location civic report 340. Thus, the position 366 can be a geodesic location, grid coordinate, etc. The position error 370 can include any estimation of error of the position 366 based on measurement inaccuracies for the location of the initiating STA 104a and/or the responding STA 102a. The position error 370 can be represented by a number of inches, feet, centimetres, etc. error, a percentage error, or other representation.

An embodiment of a beacon 374, similar to or provided in beacon 204, advertising enhanced FTM measurement capability is shown in FIG. 3C. The beacon 374 can include various beacon information 378 known in the art (and not described herein). There may be more or less information in the beacon 374 than that shown in FIG. 3C, as represented by ellipses 384. An additional or modified field 382 can include a bit or bits that indicate the responding STA 102a can provide enhanced FTM measurements, similar to those in data structure 350. If the bit or bits are sent, the initiating STA 104a understands that the responding STA 102a can send the enhanced FTM data in a FTM response 220 requested by the initiating STA 104a.

An embodiment of a FTM request 386, similar to or provided in FTM request signal 208, is shown in FIG. 3D. The FTM request 386 can include various information known in the art (and not described herein). There may be more or less information in the FTM request 386 than that shown in FIG. 3D, as represented by ellipses 396. The FTM request 386 can include an FTM Request 390 that indicates that the initiating STA 104a desires to receive FTM information from the responding STA 102a. The FTM request 390 can indicate whether the initiating STA 104a desires to receive the enhanced FTM measurements described in conjunction with FIG. 3B. The FTM request 386 can also include a ToD 394 that indicates when the current message or a previous message, used to determine FTM position, was sent. The ToD 394 can be a time measurement provided in seconds, milliseconds, picoseconds, nanseconds, etc. referenced from a clock used in the BSS.

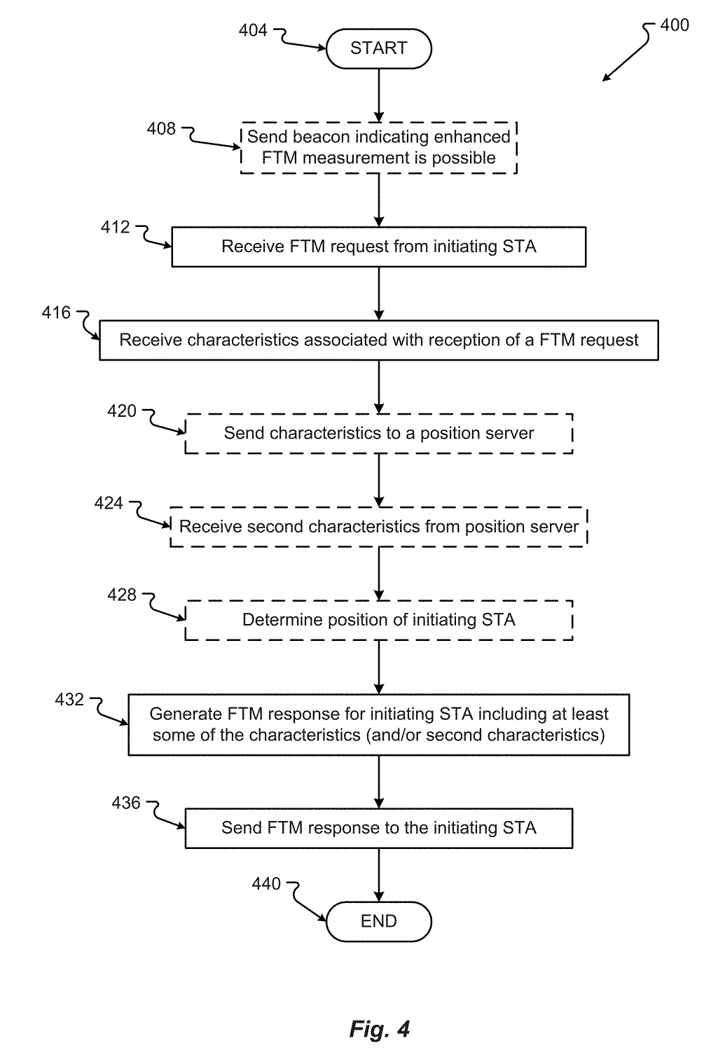

The process 400, conducted by a responding STA 102a (e.g., one or more of the AP(s) 102a-102d) may be as shown in FIG. 4. A general order for the steps of the method 400 is shown in FIG. 4. Generally, the method 400 starts with a start operation 404 and ends with operation 440. The method 400 can include more or fewer steps or can arrange the order of the steps differently than those shown in FIG. 4. The method 400 can be executed as a set of computer-executable instructions executed by a computer system or processor and encoded or stored on a computer readable medium. In other configurations, the method 400 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 400 shall be explained with reference to the systems, components, circuits, modules, software, data structures, signalling processes, etc. described in conjunction with FIGS. 1-3D and 8.

Optionally, a RF component(s) (e.g., a transmitter 888, a receiver 892, a MAC module 884, and/or a PHY module 880) of a responding STA 102a can send a beacon signal 204, including the beacon data 374, in step 408. The beacon data 374 can include a field 382 that indicates to receiving STAs 104 that the AP 102 can provide enhanced FTM measurement information.

The RF component(s) may then receive a FTM request signal 208, including the FTM request 386, in step 412. The FTM request 386 may then be passed to the positioning engine 822 executed in the controller 820. The controller 820 receives the characteristics associated with the reception of the FTM request from the RF component(s), such as the AoA 354 or other data described hereinbefore, in step 416. Optionally, the controller 820 then can compose a message to send through the network interface 896 to the position server 108 as signal 212b, in step 420.

Optionally, the network interface 896 may then receive a message 216 from the position server 108, in step 424. The message 216 can include second characteristics from one or more of the additional responding STAs 102b-102d received by the position server 108. The second characteristics can include the AoA 354 or other data described hereinbefore associated with the reception of the FTM request 208b at at least one the additional responding STAs 102b-102d. The positioning engine 822 can then receive the second characteristics from the network interface 896.

From the characteristics from the RF component(s) and the second characteristics provided by the position server 108, the positioning engine 822 can optionally determine a position of the initiating STA 104a. The characteristics, second characteristics, and/or determined position may then be incorporated into a FTM response 350 generated by the positioning engine 822, in step 432. The FTM response 350 may then be incorporated into a message 220 sent back to the initiating STA 104a by the RF component(s), in step 436.

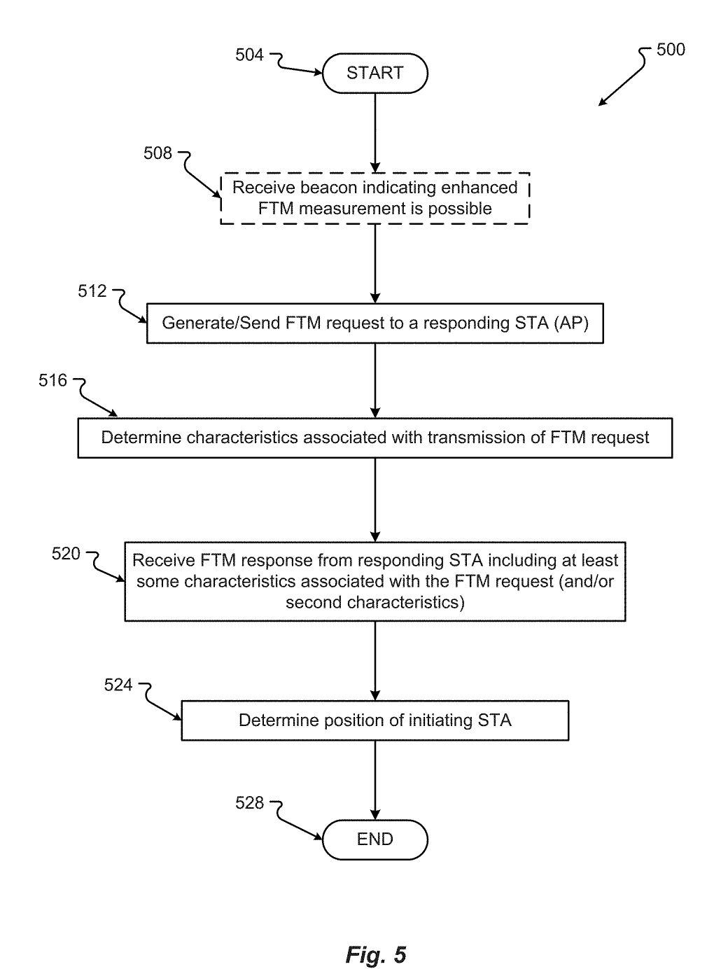

The process 500, conducted by the STA 104d, may be as shown in FIG. 5. A general order for the steps of the method 500 is shown in FIG. 5. Generally, the method 500 starts with a start operation 504 and ends with operation 528. The method 500 can include more or fewer steps or can arrange the order of the steps differently than those shown in FIG. 5. The method 500 can be executed as a set of computer-executable instructions executed by a computer system or processor and encoded or stored on a computer readable medium. In other configurations, the method 500 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 500 shall be explained with reference to the systems, components, circuits, modules, software, data structures, signalling processes, etc. described in conjunction with FIGS. 1-4 and 8.

Optionally, a RF component(s) of an initiating STA 104a can receive a beacon signal 204, including the beacon data 374, in step 508. The beacon data 374 can include a field 382 that indicates to the initiating STA 104a that the AP 102 (the responding STA 102a) can provide enhanced FTM measurement information.

The positioning engine 822, executed by the controller 820 may then generate a FTM request 386. The FTM request 386 can, in some configurations, request the enhanced FTM measurement information in field 390. Optionally, the FTM request 386 may also include information about the signal to be sent, such as the ToD 394. The RF component(s) of the initiating STA 104a may then send a FTM request signal 208, including the FTM request 386, in step 512.

The controller 820 of the initiating STA 104a can receive the characteristics associated with the transmission of the FTM request 208 from the RF component(s), such as the ToD 394 or other data described hereinbefore, in step 516. The RF component(s) may then receive the FTM response signal 220 that includes the FTM response 350, in step 520. The enhanced FTM measurement information, second characteristics from the additional responding STAs 102b-102d, and/or a determined position may be incorporated into the FTM response 350 received from the responding STA 102a. The enhanced FTM measurement information and second characteristics in the FTM response 350 can include the AoA 354, the other data in data structure 350, or other information described above.

Based on the received information from signal 220 or the characteristics provided by the RF component(s), the positioning engine 822 of the initiating STA 104a can determine a position of the initiating STA 104a, in step 524. The position determination may be made by determining where in a geodesic space the AoA and range (based on the ToF) locates the initiating STA 104a. These techniques are known and not described in detail here.

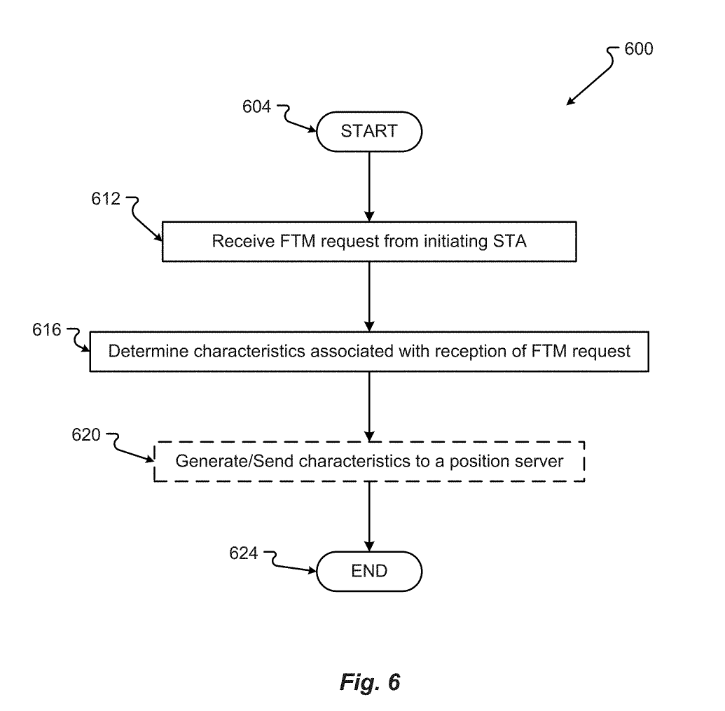

The process 600, conducted by one or more of the AP(s) 102b-102d, may be as shown in FIG. 6. A general order for the steps of the method 600 is shown in FIG. 6. Generally, the method 600 starts with a start operation 606 and ends with operation 624. The method 600 can include more or fewer steps or can arrange the order of the steps differently than those shown in FIG. 6. The method 600 can be executed as a set of computer-executable instructions executed by a computer system or processor and encoded or stored on a computer readable medium. In other configurations, the method 600 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 600 shall be explained with reference to the systems, components, circuits, modules, software, data structures, signalling processes, etc. described in conjunction with FIGS. 1-5 and 8.

The RF component(s) of one or more of the additional responding STAs 102b-102d may receive a FTM request signal 208b, including the FTM request 386, in step 612. The FTM request 386 may then be passed to the positioning engine 822 executed in the controller 820. The controller 820 receives the characteristics associated with the reception of the FTM request from the RF component(s), such as the AoA 354 or other data described hereinbefore, in step 616. Optionally, the controller 820 then can compose a message to send through the network interface 896 to the position server 108 as signal 212a, in step 620.

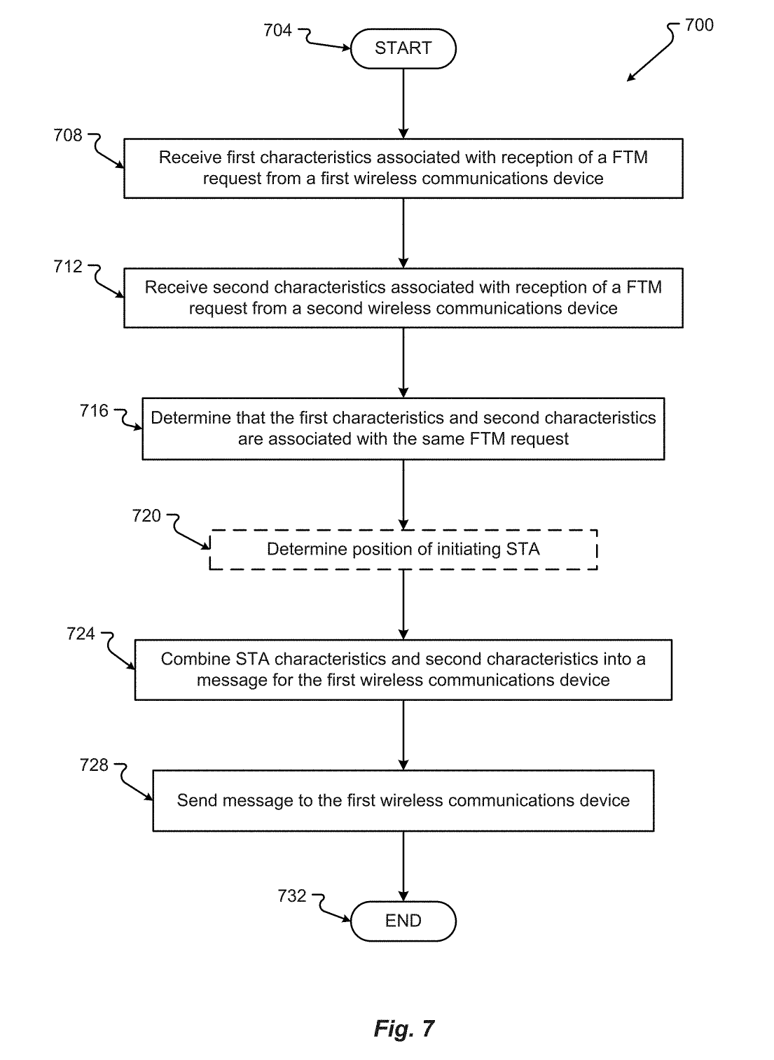

The process 700, conducted by the position server 108, may be as shown in FIG. 7. A general order for the steps of the method 700 is shown in FIG. 7. Generally, the method 700 starts with a start operation 707 and ends with operation 732. The method 700 can include more or fewer steps or can arrange the order of the steps differently than those shown in FIG. 7. The method 700 can be executed as a set of computer-executable instructions executed by a computer system or processor and encoded or stored on a computer readable medium. In other configurations, the method 700 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 700 shall be explained with reference to the systems, components, circuits, modules, software, data structures, signalling processes, etc. described in conjunction with FIGS. 1-6 and 8.

The controller 820 of the position server 108 can receive, through the network interface 896, as signal 212b, a first set of characteristics, associated with the reception of an FTM request 386 at a responding STA 102a, in step 708. The controller 820 of the position server 108 can also receive, through the network interface 896 as signal 212a, a second set of characteristics, associated with the reception of the same FTM request 386 at one or more of the additional responding STAs 102b-102d, in step 712. Based on the information in signals 212a and 212b, the controller 820 can determine that the first characteristics and second characteristics are associated with the same FTM request 386, in step 716. In one configuration, an identifier associated with the FTM request 386, such as a dialog token 312, may indicate the first characteristics and second characteristics are associated with the same FTM request 386.

Optionally, the positioning engine 822 of the position server 108 can, determine a position of the initiating STA 104a based on the first characteristics and second characteristics, in step 720. As described previously, known methods for determining position using the AoA and ToF of the received FTM request 208 from the responding STA 102a and at least one of the additional responding STAs 102b-102d can be used to determine the position of the initiating STA 104a.

The positioning engine 822 may then incorporate or combined the first characteristics and second characteristics (and optionally with the determined position) into a message for the responding STA 102a, in step 724. The network interface 896 may then send the message, as signal 216, to the initiating STA 104a, in step 728.

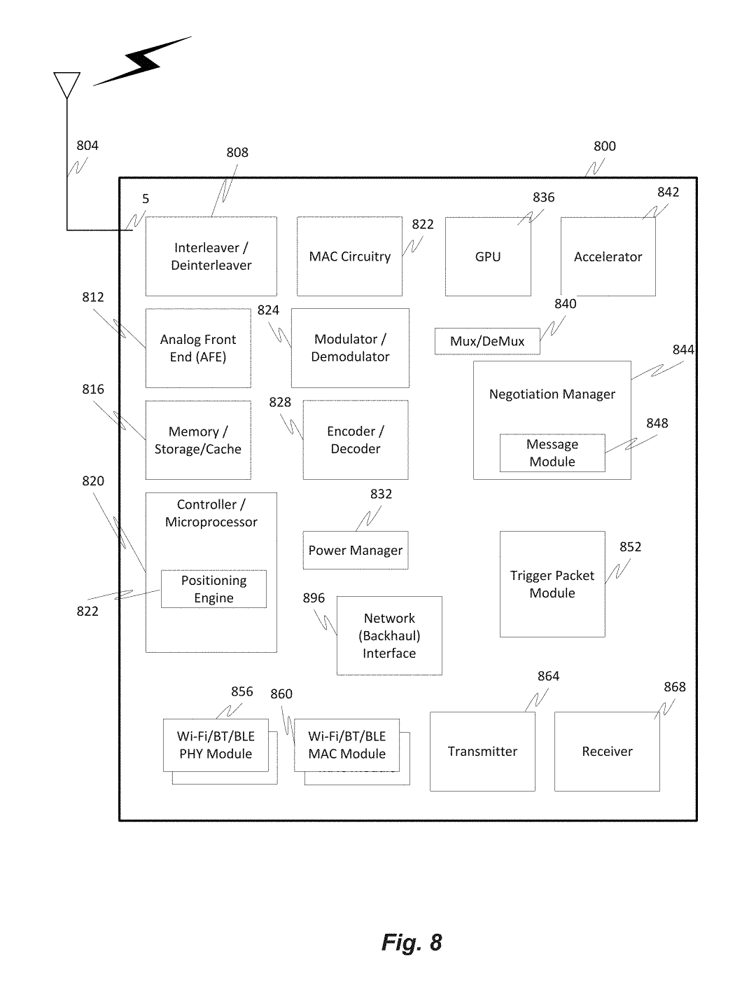

FIG. 8 illustrates an exemplary hardware diagram of a device 800, such as a wireless device, mobile device, access point, station, and/or the like, that is adapted to implement the technique(s) discussed herein. Operation will be discussed in relation to the components in FIG. 8 appreciating that each separate device in a system, e.g., station, AP, proxy server, etc., can include one or more of the components shown in the figure, with the components each being optional.

In addition to well-known componentry (which has been omitted for clarity), the device 800 includes interconnected elements (with links 5 omitted for clarity) including one or more of: one or more antennas 804, an interleaver/deinterleaver 808, an analog front end (AFE) 812, memory/storage/cache 816, controller/microprocessor 820, MAC circuitry 822, modulator/demodulator 824, encoder/decoder 828, power manager 832, GPU 836, accelerator 842, a multiplexer/demultiplexer 840, a negotiation manager 844, message module 848, trigger packet module 852, and wireless radio components such as a Wi-Fi/BT/BLE PHY module 856, a Wi-Fi/BT/BLE MAC module 860, transmitter 864 and receiver 868. The various elements in the device 800 are connected by one or more links (not shown, again for sake of clarity). As one example, the negotiation manager 844 and message module 848 can be embodied as a process executing on a processor or controller, such as processor 820 with the cooperation of the memory 816. The negotiation manager 844 and message module 848 could also be embodied as an ASIC and/or as part of a system on a chip. In some configurations, there can be multiple instances of the PHY Module/Circuitry 856, MAC circuitry 822, transmitter 864, and/or receiver 868, wherein each instance of the PHY Module/Circuitry 856, MAC circuitry 822, transmitter 864, and/or receiver 868 sends/receives data over a specific band (e.g., 2.45 GHz, 915 MHz, 5.2 GHz, etc.) to facilitate multi-band transmissions.

The device 800 can have one more antennas 804, for use in wireless communications such as multi-input multi-output (MIMO) communications, multi-user multi-input multi-output (MU-MIMO) communications Bluetooth®, LTE, RFID, 4G, LTE, etc. The antenna(s) 804 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 804 generally interact with the Analog Front End (AFE) 812, which is needed to enable the correct processing of the received modulated signal and signal conditioning for a transmitted signal. The AFE 812 can be functionally located between the antenna and a digital baseband system to convert the analog signal into a digital signal for processing and vice-versa.

The device 800 can also include a controller/microprocessor 820 and a memory/storage/cache 816. The device 800 can interact with the memory/storage/cache 816 which may store information and operations necessary for configuring and transmitting or receiving the information described herein. The memory/storage/cache 816 may also be used in connection with the execution of application programming or instructions by the controller/microprocessor 820, and for temporary or long term storage of program instructions and/or data. As examples, the memory/storage/cache 820 may comprise a computer-readable device, RAM, ROM, DRAM, SDRAM, and/or other storage device(s) and media.

The controller/microprocessor 820 may comprise a general purpose programmable processor or controller for executing application programming or instructions related to the device 800. Furthermore, the controller/microprocessor 820 can perform operations for configuring and transmitting information as described herein. The controller/microprocessor 820 may include multiple processor cores, and/or implement multiple virtual processors. Optionally, the controller/microprocessor 820 may include multiple physical processors. By way of example, the controller/microprocessor 820 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 800 can further include a transmitter 864 and receiver 868 which can transmit and receive signals, respectively, to and from other wireless devices and/or access points using the one or more antennas 804. Included in the device 800 circuitry is the medium access control or MAC Circuitry 822. MAC circuitry 822 provides for controlling access to the wireless medium. In an exemplary embodiment, the MAC circuitry 822 may be arranged to contend for the wireless medium and configure frames or packets for communicating over the wireless medium.

The PHY Module/Circuitry 856 controls the electrical and physical specifications for device 800. In particular, PHY Module/Circuitry 856 manages the relationship between the device 800 and a transmission medium. Primary functions and services performed by the physical layer, and in particular the PHY Module/Circuitry 856, include the establishment and termination of a connection to a communications medium, and participation in the various process and technologies where communication resources shared between, for example, among multiple STAs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 856 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 822 handle co-ordination of interactions between the MAC and PHY layers.

The interleaver/deinterleaver 808 cooperates with the various PHY components to provide Forward Error correction capabilities. The modulator/demodulator 824 similarly cooperates with the various PHY components to perform modulation which in general is a process of varying one or more properties of a periodic waveform, referred to and known as a carrier signal, with a modulating signal that typically contains information for transmission. The encoder/decoder 828 manages the encoding/decoding used with the various transmission and reception elements in device 800.

The MAC layer and components, and in particular the MAC module 860 and MAC circuitry 822 provide functional and procedural means to transfer data between network entities and to detect and possibly correct errors that may occur in the physical layer. The MAC module 860 and MAC circuitry 822 also provide access to contention-based and contention-free traffic on different types of physical layers, such as when multiple communications technologies are incorporated into the device 800. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 800 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 842 can cooperate with MAC circuitry 822 to, for example, perform real-time MAC functions. The GPU 836 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

The positioning engine 822 can be any software and/or hardware to conduct the operations described herein. In some configurations, the positioning engine 822 is a set of instructions executed by the controller 820 to receive FTM requests, determine positions of initiating STAs 104a, compile the FTM responses, etc. associated with the enhanced FTM measurement procedure.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments are described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising: a controller to: receive a Fine Time Measurement (FTM) request from an initiating station (STA); generate a FTM response, the FTM response comprising one or more of an angle of arrival (AoA), an AoA error, an antenna orientation, a position, and/or a position error; a wireless transmitter in communication with the controller, the wireless transmitter to: receive a FTM request signal, including the FTM request, from the initiating STA; send the FTM request to the controller; and receive the FTM response from the controller; and send a FTM response signal, including the FTM response, to the initiating STA.

Any of the one or more above aspects, further comprising: the controller to determine the AoA, the AoA error, the antenna orientation, the position, and/or the position error for the FTM request.

Any of the one or more above aspects, further comprising: the controller to determine a time of departure (ToD) and/or a time of arrival (ToA) for the FTM request.

Any of the one or more above aspects, wherein the FTM response further comprises the ToD and/or the ToA.

Any of the one or more above aspects, further comprising: the controller to send one or more of the AoA, the AoA error, the antenna orientation, the position, the position error, and/or the ToA to a position server.

Any of the one or more above aspects, further comprising: the controller to receive one or more of a second AoA, a second AoA error, a second antenna orientation, a second position, a second position error, and/or a second ToA, associated with a second wireless communications device, from the position server.

Any of the one or more above aspects, further comprising: including the second AoA, the second AoA error, the second antenna orientation, the second position, the second position error, and/or the second ToA, associated with the second wireless communications device in the FTM response.

Any of the one or more above aspects, wherein the initiating STA determines a second position of the initiating STA based on the FTM response.

Any of the one or more above aspects, wherein the controller determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

A method comprising: a controller of a wireless communications device receiving a Fine Time Measurement (FTM) request from an initiating station (STA); the controller of the wireless communications device generating a FTM response, the FTM response comprising one or more of an angle of approach (AoA), an AoA error, an antenna orientation, a position, and/or a position error; a wireless transceiver of the wireless communications device sending a FTM response signal, including the FTM response, to the initiating STA.

Any of the one or more above aspects, further comprising determining the AoA, the AoA error, the antenna orientation, the position, and/or the position error for the FTM request.

Any of the one or more above aspects, further comprising determining a time of departure (ToD) and/or a time of arrival (ToA) for the FTM request.

Any of the one or more above aspects, wherein the FTM response further comprises the ToD and/or the ToA.

Any of the one or more above aspects, further comprising sending one or more of the AoA, the AoA error, the antenna orientation, the position, the position error, and/or the ToA to a position server.

Any of the one or more above aspects, further comprising receiving one or more of a second AoA, a second AoA error, a second antenna orientation, a second position, a second position error, and/or a second ToA, associated with a second wireless communications device, from the position server.

Any of the one or more above aspects, further comprising including the second AoA, the second AoA error, the second antenna orientation, the second position, the second position error, and/or the second ToA, associated with the second wireless communications device in the FTM response.

Any of the one or more above aspects, wherein the initiating STA determines a second position of the initiating STA based on the FTM response.

Any of the one or more above aspects, wherein the controller determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

A wireless communications device comprising:

means for receiving a Fine Time Measurement (FTM) request from an initiating station (STA); means for generating a FTM response, the FTM response comprising one or more of an angle of approach (AoA), an AoA error, an antenna orientation, a position, and/or a position error; means for sending a FTM response signal, including the FTM response, to the initiating STA.

Any of the one or more above aspects, further comprising means for determining the AoA, the AoA error, the antenna orientation, the position, and/or the position error for the FTM request.

Any of the one or more above aspects, further comprising means for determining a time of departure (ToD) and/or a time of arrival (ToA) for the FTM request.

Any of the one or more above aspects, wherein the FTM response further comprises the ToD and/or the ToA.

Any of the one or more above aspects, further comprising means for sending one or more of the AoA, the AoA error, the antenna orientation, the position, the position error, and/or the ToA to a position server.

Any of the one or more above aspects, further comprising means for receiving one or more of a second AoA, a second AoA error, a second antenna orientation, a second position, a second position error, and/or a second ToA, associated with a second wireless communications device, from the position server.

Any of the one or more above aspects, further comprising means for including the second AoA, the second AoA error, the second antenna orientation, the second position, the second position error, and/or the second ToA, associated with the second wireless communications device in the FTM response.

Any of the one or more above aspects, wherein the initiating STA determines a second position of the initiating STA based on the FTM response.

Any of the one or more above aspects, wherein the controller determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

A non-transitory information storage media having stored thereon one or more instructions, that when executed by one or more processors, cause a wireless communications device to perform a method, the method comprising: receiving a Fine Time Measurement (FTM) request from an initiating station (STA); generating a FTM response, the FTM response comprising one or more of an angle of approach (AoA), an AoA error, an antenna orientation, a position, and/or a position error; sending a FTM response signal, including the FTM response, to the initiating STA.

Any of the one or more above aspects, the method further comprising determining the AoA, the AoA error, the antenna orientation, the position, and/or the position error for the FTM request.

Any of the one or more above aspects, the method further comprising determining a time of departure (ToD) and/or a time of arrival (ToA) for the FTM request.

Any of the one or more above aspects, wherein the FTM response further comprises the ToD and/or the ToA.

Any of the one or more above aspects, the method further comprising sending one or more of the AoA, the AoA error, the antenna orientation, the position, the position error, and/or the ToA to a position server.

Any of the one or more above aspects, the method further comprising receiving one or more of a second AoA, a second AoA error, a second antenna orientation, a second position, a second position error, and/or a second ToA, associated with a second wireless communications device, from the position server.

Any of the one or more above aspects, the method further comprising including the second AoA, the second AoA error, the second antenna orientation, the second position, the second position error, and/or the second ToA, associated with the second wireless communications device in the FTM response.

Any of the one or more above aspects, wherein the initiating STA determines a second position of the initiating STA based on the FTM response.

Any of the one or more above aspects, wherein the controller determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

A wireless communications device comprising: a controller to: generate a Fine Time Measurement (FTM) request for a responding station (STA); receive a FTM response, the FTM response comprising one or more of an angle of arrival (AoA), an AoA error, an antenna orientation, a position, and/or a position error; a wireless transmitter in communication with the controller, the wireless transmitter to: receive the FTM request from the controller; send a FTM request signal, including the FTM request, to the responding STA; receive a FTM response signal, including the FTM response, from the responding STA; and send the FTM response to the controller.

Any of the one or more above aspects, further comprising: the controller to determine a time of departure (ToD) for the FTM request.

Any of the one or more above aspects, wherein the FTM response further comprises a time of arrival (ToA) and/or a time of departure (ToD) associated with the FTM request.

Any of the one or more above aspects, further comprising: the controller to receive one or more of a second AoA, a second AoA error, a second antenna orientation, a second position, a second position error, and/or a second ToA, associated with a second wireless communications device, from a position server.

Any of the one or more above aspects, wherein the second AoA, the second AoA error, the second antenna orientation, the second position, the second position error, and/or the second ToA, associated with the second wireless communications device, is included in the FTM response.

Any of the one or more above aspects, wherein the second AoA, the second AoA error, the second antenna orientation, the second position, the second position error, and/or the second ToA, associated with the second wireless communications device, is included in a second signal from a second responding STA.

Any of the one or more above aspects, further comprising: the controller to determine a second position of the wireless communications device based on the FTM response.

Any of the one or more above aspects, wherein the responding STA determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the wireless communications device is a mobile device inside a physical structure and cannot receive a global positioning system (GPS) signal to determine the position.

A method comprising: generating a Fine Time Measurement (FTM) request for a responding station (STA); sending a FTM request signal, including the FTM request, to the responding STA; and receiving a FTM response, the FTM response comprising one or more of an angle of arrival (AoA), an AoA error, an antenna orientation, a position, and/or a position error.

Any of the one or more above aspects, further comprising determining a time of departure (ToD) for the FTM request.

Any of the one or more above aspects, wherein the FTM response further comprises a time of arrival (ToA) and/or a time of departure (ToD) associated with the FTM request.

Any of the one or more above aspects, further comprising receiving one or more of a second AoA, a second AoA error, a second antenna orientation, a second position, a second position error, and/or a second ToA, associated with a second wireless communications device, from a position server.

Any of the one or more above aspects, wherein the second AoA, the second AoA error, the second antenna orientation, the second position, the second position error, and/or the second ToA, associated with the second wireless communications device, is included in the FTM response.

Any of the one or more above aspects, wherein the second AoA, the second AoA error, the second antenna orientation, the second position, the second position error, and/or the second ToA, associated with the second wireless communications device, is included in a second signal from a second responding STA.

Any of the one or more above aspects, further comprising determining a second position of the wireless communications device based on the FTM response.

Any of the one or more above aspects, wherein the responding STA determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the wireless communications device is a mobile device inside a physical structure and cannot receive a global positioning system (GPS) signal to determine the position.

A wireless communications device comprising: means for generating a Fine Time Measurement (FTM) request for a responding station (STA); means for sending a FTM request signal, including the FTM request, to the responding STA; and means for receiving a FTM response, the FTM response comprising one or more of an angle of arrival (AoA), an AoA error, an antenna orientation, a position, and/or a position error.

Any of the one or more above aspects, further comprising means for determining a time of departure (ToD) for the FTM request.

Any of the one or more above aspects, wherein the FTM response further comprises a time of arrival (ToA) and/or a time of departure (ToD) associated with the FTM request.

Any of the one or more above aspects, further comprising means for receiving one or more of a second AoA, a second AoA error, a second antenna orientation, a second position, a second position error, and/or a second ToA, associated with a second wireless communications device, from a position server.

Any of the one or more above aspects, wherein the second AoA, the second AoA error, the second antenna orientation, the second position, the second position error, and/or the second ToA, associated with the second wireless communications device, is included in the FTM response.

Any of the one or more above aspects, wherein the second AoA, the second AoA error, the second antenna orientation, the second position, the second position error, and/or the second ToA, associated with the second wireless communications device, is included in a second signal from a second responding STA.

Any of the one or more above aspects, further comprising means for determining a second position of the wireless communications device based on the FTM response.

Any of the one or more above aspects, wherein the responding STA determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the wireless communications device is a mobile device inside a physical structure and cannot receive a global positioning system (GPS) signal to determine the position.

A non-transitory information storage media having stored thereon one or more instructions, that when executed by one or more processors, cause a wireless communications device to perform a method, the method comprising: generating a Fine Time Measurement (FTM) request for a responding station (STA); sending a FTM request signal, including the FTM request, to the responding STA; and receiving a FTM response, the FTM response comprising one or more of an angle of arrival (AoA), an AoA error, an antenna orientation, a position, and/or a position error.

Any of the one or more above aspects, the method further comprising determining a time of departure (ToD) for the FTM request.

Any of the one or more above aspects, wherein the FTM response further comprises a time of arrival (ToA) and/or a time of departure (ToD) associated with the FTM request.

Any of the one or more above aspects, the method further comprising receiving one or more of a second AoA, a second AoA error, a second antenna orientation, a second position, a second position error, and/or a second ToA, associated with a second wireless communications device, from a position server.

Any of the one or more above aspects, wherein the second AoA, the second AoA error, the second antenna orientation, the second position, the second position error, and/or the second ToA, associated with the second wireless communications device, is included in the FTM response.

Any of the one or more above aspects, wherein the second AoA, the second AoA error, the second antenna orientation, the second position, the second position error, and/or the second ToA, associated with the second wireless communications device, is included in a second signal from a second responding STA.

Any of the one or more above aspects, the method further comprising determining a second position of the wireless communications device based on the FTM response.

Any of the one or more above aspects, wherein the responding STA determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the wireless communications device is a mobile device inside a physical structure and cannot receive a global positioning system (GPS) signal to determine the position.

A wireless communications device comprising: a controller to: receive a Fine Time Measurement (FTM) request from an initiating station (STA); generate one or more of an angle of arrival (AoA), an AoA error, an antenna orientation, a position, and/or a position error; a network interface in communication with the controller, the network interface to send the one or more of the angle of arrival (AoA), the AoA error, the antenna orientation, the position, and/or the position error to a position server.

Any of the one or more above aspects, further comprising: the controller to determine the AoA, the AoA error, the antenna orientation, the position, and/or the position error for the FTM request.

Any of the one or more above aspects, further comprising: the controller to determine a time of arrival (ToA) and/or a time of departure (ToD) for the FTM request.

Any of the one or more above aspects, wherein the network interface also sends the ToD and/or the ToA to the position server.

Any of the one or more above aspects, wherein the position server is associated with a basic service set (BSS) that includes the wireless communications device.

Any of the one or more above aspects, wherein the position server receives one or more of a second AoA, a second AoA error, a second antenna orientation, a second position, a second position error, and/or a second ToA, associated with a second wireless communications device.

Any of the one or more above aspects, wherein the second wireless communications device includes the AoA, the AoA error, the antenna orientation, the position, the position error, the ToD, and/or the ToA, associated with the wireless communications device, in a FTM response.

Any of the one or more above aspects, wherein the initiating STA determines a second position of the initiating STA based on the FTM response.

Any of the one or more above aspects, wherein the second wireless communications device determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

A method comprising: receiving a Fine Time Measurement (FTM) request from an initiating station (STA); generating one or more of an angle of arrival (AoA), an AoA error, an antenna orientation, a position, and/or a position error; sending the one or more of the angle of arrival (AoA), the AoA error, the antenna orientation, the position, and/or the position error to a position server.

Any of the one or more above aspects, further comprising determining the AoA, the AoA error, the antenna orientation, the position, and/or the position error for the FTM request.

Any of the one or more above aspects, further comprising determining a time of arrival (ToA) and/or a time of departure (ToD) for the FTM request.

Any of the one or more above aspects, wherein the network interface also sends the ToD and/or the ToA to the position server.

Any of the one or more above aspects, wherein the position server is associated with a basic service set (BSS) that includes the wireless communications device.

Any of the one or more above aspects, wherein the position server receives one or more of a second AoA, a second AoA error, a second antenna orientation, a second position, a second position error, and/or a second ToA, associated with a second wireless communications device.

Any of the one or more above aspects, wherein the second wireless communications device includes the AoA, the AoA error, the antenna orientation, the position, the position error, the ToD, and/or the ToA, associated with the wireless communications device, in a FTM response.

Any of the one or more above aspects, wherein the initiating STA determines a second position of the initiating STA based on the FTM response.

Any of the one or more above aspects, wherein the second wireless communications device determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

A wireless communications device comprising: means for receiving a Fine Time Measurement (FTM) request from an initiating station (STA); means for generating one or more of an angle of arrival (AoA), an AoA error, an antenna orientation, a position, and/or a position error; means for sending the one or more of the angle of arrival (AoA), the AoA error, the antenna orientation, the position, and/or the position error to a position server.

Any of the one or more above aspects, further comprising means for determining the AoA, the AoA error, the antenna orientation, the position, and/or the position error for the FTM request.

Any of the one or more above aspects, further comprising means for determining a time of arrival (ToA) and/or a time of departure (ToD) for the FTM request.

Any of the one or more above aspects, wherein the network interface also sends the ToD and/or the ToA to the position server.

Any of the one or more above aspects, wherein the position server is associated with a basic service set (BSS) that includes the wireless communications device.

Any of the one or more above aspects, wherein the position server receives one or more of a second AoA, a second AoA error, a second antenna orientation, a second position, a second position error, and/or a second ToA, associated with a second wireless communications device.

Any of the one or more above aspects, wherein the second wireless communications device includes the AoA, the AoA error, the antenna orientation, the position, the position error, the ToD, and/or the ToA, associated with the wireless communications device, in a FTM response.

Any of the one or more above aspects, wherein the initiating STA determines a second position of the initiating STA based on the FTM response.

Any of the one or more above aspects, wherein the second wireless communications device determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

A non-transitory information storage media having stored thereon one or more instructions, that when executed by one or more processors, cause a wireless communications device to perform a method, the method comprising: means for receiving a Fine Time Measurement (FTM) request from an initiating station (STA); means for generating one or more of an angle of arrival (AoA), an AoA error, an antenna orientation, a position, and/or a position error; means for sending the one or more of the angle of arrival (AoA), the AoA error, the antenna orientation, the position, and/or the position error to a position server.

Any of the one or more above aspects, the method further comprising determining the AoA, the AoA error, the antenna orientation, the position, and/or the position error for the FTM request.

Any of the one or more above aspects, the method further comprising determining a time of arrival (ToA) and/or a time of departure (ToD) for the FTM request.

Any of the one or more above aspects, wherein the network interface also sends the ToD and/or the ToA to the position server.

Any of the one or more above aspects, wherein the position server is associated with a basic service set (BSS) that includes the wireless communications device.

Any of the one or more above aspects, wherein the position server receives one or more of a second AoA, a second AoA error, a second antenna orientation, a second position, a second position error, and/or a second ToA, associated with a second wireless communications device.

Any of the one or more above aspects, wherein the second wireless communications device includes the AoA, the AoA error, the antenna orientation, the position, the position error, the ToD, and/or the ToA, associated with the wireless communications device, in a FTM response.

Any of the one or more above aspects, wherein the initiating STA determines a second position of the initiating STA based on the FTM response.

Any of the one or more above aspects, wherein the second wireless communications device determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

Any of the one or more above aspects, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

A position server comprising: a network interface to: receive one or more of a first angle of arrival (AoA), a first AoA error, a first antenna orientation, a first position, and/or a first position error from a first wireless communications device; receive one or more of a second angle of arrival (AoA), a second AoA error, a second antenna orientation, a second position, and/or a second position error from a second wireless communications device; send the one or more of the first angle of arrival (AoA), the first AoA error, the first antenna orientation, the first position, the first position error, the second angle of arrival (AoA), the second AoA error, the second antenna orientation, the second position, and/or the second position error to the first wireless communications device; a controller in communication with the network interface, the controller to associate the one or more of the first angle of arrival (AoA), the first AoA error, the first antenna orientation, the first position, the first position error, the second angle of arrival (AoA), the second AoA error, the second antenna orientation, the second position, and/or the second position error to the first wireless communications device.

Any of the one or more above aspects, further comprising: the controller to determine the one or more of the first angle of arrival (AoA), the first AoA error, the first antenna orientation, the first position, and/or the first position error is associated with a FTM request from an initiating station (STA).

Any of the one or more above aspects, further comprising: the controller to determine the one or more of the second angle of arrival (AoA), the second AoA error, the second antenna orientation, the second position, and/or the second position error is associated with the FTM request from the initiating station (STA).

Any of the one or more above aspects, further comprising the network interface to: receive a first time of arrival (ToA) and/or a first time of departure (ToD) for the FTM request from the first wireless communications device; and receive a second time of arrival (ToA) and/or a second time of departure (ToD) for the FTM request from the second wireless communications device.

Any of the one or more above aspects, wherein the controller also associates the first ToD, the first ToA, the second ToD, and/or the second ToA with the FTM request.

Any of the one or more above aspects, wherein the network interface also to send the first ToD, the first ToA, the second ToD, and/or the second ToA to the first wireless communications device.

Any of the one or more above aspects, wherein the position server is associated with a basic service set (BSS) that includes the first wireless communications device and the second wireless communications device.

Any of the one or more above aspects, wherein the first wireless communications device includes one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA, associated with the FTM request, in a FTM response.

Any of the one or more above aspects, wherein the initiating STA determines a second position of the initiating STA based on the FTM response.

Any of the one or more above aspects, wherein one of: the first wireless communications device determines a second position of the initiating STA based on one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA; or the position server determines a second position of the initiating STA based on one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA.

A method comprising: receiving one or more of a first angle of arrival (AoA), a first AoA error, a first antenna orientation, a first position, and/or a first position error from a first wireless communications device; receiving one or more of a second angle of arrival (AoA), a second AoA error, a second antenna orientation, a second position, and/or a second position error from a second wireless communications device; sending the one or more of the first angle of arrival (AoA), the first AoA error, the first antenna orientation, the first position, the first position error, the second angle of arrival (AoA), the second AoA error, the second antenna orientation, the second position, and/or the second position error to the first wireless communications device; associating the one or more of the first angle of arrival (AoA), the first AoA error, the first antenna orientation, the first position, the first position error, the second angle of arrival (AoA), the second AoA error, the second antenna orientation, the second position, and/or the second position error to the first wireless communications device;

Any of the one or more above aspects, further comprising determining the one or more of the first angle of arrival (AoA), the first AoA error, the first antenna orientation, the first position, and/or the first position error is associated with a FTM request from an initiating station (STA).

Any of the one or more above aspects, further comprising determining the one or more of the second angle of arrival (AoA), the second AoA error, the second antenna orientation, the second position, and/or the second position error is associated with the FTM request from the initiating station (STA).

Any of the one or more above aspects, further comprising: receiving a first time of arrival (ToA) and/or a first time of departure (ToD) for the FTM request from the first wireless communications device; and receiving a second time of arrival (ToA) and/or a second time of departure (ToD) for the FTM request from the second wireless communications device.

Any of the one or more above aspects, wherein the controller also associates the first ToD, the first ToA, the second ToD, and/or the second ToA with the FTM request.

Any of the one or more above aspects, wherein the network interface also to send the first ToD, the first ToA, the second ToD, and/or the second ToA to the first wireless communications device.

Any of the one or more above aspects, wherein the position server is associated with a basic service set (BSS) that includes the first wireless communications device and the second wireless communications device.

Any of the one or more above aspects, wherein the first wireless communications device includes one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA, associated with the FTM request, in a FTM response.

Any of the one or more above aspects, wherein the initiating STA determines a second position of the initiating STA based on the FTM response.

Any of the one or more above aspects, wherein one of: the first wireless communications device determines a second position of the initiating STA based on one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA; or the position server determines a second position of the initiating STA based on one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA.

A non-transitory information storage media having stored thereon one or more instructions, that when executed by one or more processors, cause a wireless communications device to perform a method, the method comprising: receiving one or more of a first angle of arrival (AoA), a first AoA error, a first antenna orientation, a first position, and/or a first position error from a first wireless communications device; receiving one or more of a second angle of arrival (AoA), a second AoA error, a second antenna orientation, a second position, and/or a second position error from a second wireless communications device; sending the one or more of the first angle of arrival (AoA), the first AoA error, the first antenna orientation, the first position, the first position error, the second angle of arrival (AoA), the second AoA error, the second antenna orientation, the second position, and/or the second position error to the first wireless communications device; and associating the one or more of the first angle of arrival (AoA), the first AoA error, the first antenna orientation, the first position, the first position error, the second angle of arrival (AoA), the second AoA error, the second antenna orientation, the second position, and/or the second position error to the first wireless communications device.

Any of the one or more above aspects, the method further comprising determining the one or more of the first angle of arrival (AoA), the first AoA error, the first antenna orientation, the first position, and/or the first position error is associated with a FTM request from an initiating station (STA).

Any of the one or more above aspects, the method further comprising determining the one or more of the second angle of arrival (AoA), the second AoA error, the second antenna orientation, the second position, and/or the second position error is associated with the FTM request from the initiating station (STA).

Any of the one or more above aspects, the method further comprising: receiving a first time of arrival (ToA) and/or a first time of departure (ToD) for the FTM request from the first wireless communications device; and receiving a second time of arrival (ToA) and/or a second time of departure (ToD) for the FTM request from the second wireless communications device.

Any of the one or more above aspects, wherein the controller also associates the first ToD, the first ToA, the second ToD, and/or the second ToA with the FTM request.

Any of the one or more above aspects, wherein the network interface also to send the first ToD, the first ToA, the second ToD, and/or the second ToA to the first wireless communications device.

Any of the one or more above aspects, wherein the position server is associated with a basic service set (BSS) that includes the first wireless communications device and the second wireless communications device.

Any of the one or more above aspects, wherein the first wireless communications device includes one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA, associated with the FTM request, in a FTM response.

Any of the one or more above aspects, wherein the initiating STA determines a second position of the initiating STA based on the FTM response.

Any of the one or more above aspects, wherein one of: the first wireless communications device determines a second position of the initiating STA based on one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA; or the position server determines a second position of the initiating STA based on one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA.

A wireless communications device comprising: means for receiving one or more of a first angle of arrival (AoA), a first AoA error, a first antenna orientation, a first position, and/or a first position error from a first wireless communications device; means for receiving one or more of a second angle of arrival (AoA), a second AoA error, a second antenna orientation, a second position, and/or a second position error from a second wireless communications device; means for sending the one or more of the first angle of arrival (AoA), the first AoA error, the first antenna orientation, the first position, the first position error, the second angle of arrival (AoA), the second AoA error, the second antenna orientation, the second position, and/or the second position error to the first wireless communications device; and means for associating the one or more of the first angle of arrival (AoA), the first AoA error, the first antenna orientation, the first position, the first position error, the second angle of arrival (AoA), the second AoA error, the second antenna orientation, the second position, and/or the second position error to the first wireless communications device.

Any of the one or more above aspects, further comprising means for determining the one or more of the first angle of arrival (AoA), the first AoA error, the first antenna orientation, the first position, and/or the first position error is associated with a FTM request from an initiating station (STA).

Any of the one or more above aspects, further comprising means for determining the one or more of the second angle of arrival (AoA), the second AoA error, the second antenna orientation, the second position, and/or the second position error is associated with the FTM request from the initiating station (STA).

Any of the one or more above aspects, further comprising: means for receiving a first time of arrival (ToA) and/or a first time of departure (ToD) for the FTM request from the first wireless communications device; and means for receiving a second time of arrival (ToA) and/or a second time of departure (ToD) for the FTM request from the second wireless communications device.

Any of the one or more above aspects, wherein the controller also associates the first ToD, the first ToA, the second ToD, and/or the second ToA with the FTM request.

Any of the one or more above aspects, wherein the network interface also to send the first ToD, the first ToA, the second ToD, and/or the second ToA to the first wireless communications device.

Any of the one or more above aspects, wherein the position server is associated with a basic service set (BSS) that includes the first wireless communications device and the second wireless communications device.

Any of the one or more above aspects, wherein the first wireless communications device includes one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA, associated with the FTM request, in a FTM response.

Any of the one or more above aspects, wherein the initiating STA determines a second position of the initiating STA based on the FTM response.

Any of the one or more above aspects, wherein one of: the first wireless communications device determines a second position of the initiating STA based on one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA; or the position server determines a second position of the initiating STA based on one or more of the first angle of arrival (AoA), the first AoA error, the first antenna orientation, the first position, the first position error, the second angle of arrival (AoA), the second AoA error, the second antenna orientation, the second position, the second position error the first ToD, the first ToA, the second ToD, and/or the second ToA.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture. It should be noted that a means for processing may be represented by any of the above implementations.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a controller to:
receive a Fine Time Measurement (FTM) request from an initiating station (STA);
generate a FTM response, the FTM response comprising one or more of an angle of arrival (AoA), an AoA error, an antenna orientation, a position, and/or a position error;
a wireless radio in communication with the controller, the wireless transmitter to:
receive a FTM request signal, including the FTM request, from the initiating STA;
send the FTM request to the controller; and
receive the FTM response from the controller; and
send a FTM response signal, including the FTM response, to the initiating STA.

2. The wireless communications device of claim 1, further comprising: the controller to determine the AoA, the AoA error, the antenna orientation, the position, and/or the position error for the FTM request.

3. The wireless communications device of claim 2, further comprising: the controller to determine a time of departure (ToD) and/or a time of arrival (ToA) for the FTM request.

4. The wireless communications device of claim 3, wherein the FTM response further comprises the ToD and/or the ToA.

5. The wireless communications device of claim 4, further comprising: the controller to send one or more of the AoA, the AoA error, the antenna orientation, the position, the position error, and/or the ToA to a position server.

6. The wireless communications device of claim 5, further comprising: the controller to receive one or more of a second AoA, a second AoA error, a second antenna orientation, a second position, a second position error, and/or a second ToA, associated with a second wireless communications device, from the position server.

7. The wireless communications device of claim 6, further comprising: including the second AoA, the second AoA error, the second antenna orientation, the second position, the second position error, and/or the second ToA, associated with the second wireless communications device in the FTM response.

8. The wireless communications device of claim 7, wherein the initiating STA determines a second position of the initiating STA based on the FTM response.

9. The wireless communications device of claim 7, wherein the controller determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

10. The wireless communications device of claim 7, wherein the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

11. A method comprising:
a controller of a wireless communications device receiving a Fine Time Measurement (FTM) request from an initiating station (STA);
the controller of the wireless communications device generating a FTM response, the FTM response comprising one or more of an angle of approach (AoA), an AoA error, an antenna orientation, a position, and/or a position error;
a wireless transceiver of the wireless communications device sending a FTM response signal, including the FTM response, to the initiating STA.

12. The method of claim 11, further comprising:
determining the AoA, the AoA error, the antenna orientation, the position, and/or the position error for the FTM request; and
determining a time of departure (ToD) and/or a time of arrival (ToA) for the FTM request, wherein the FTM response further comprises the ToD and/or the ToA.

13. The method of claim 12, further comprising:
sending one or more of the AoA, the AoA error, the antenna orientation, the position, the position error, and/or the ToA to a position server;
receiving one or more of a second AoA, a second AoA error, a second antenna orientation, a second position, a second position error, and/or a second ToA, associated with a second method, from the position server; and
including the second AoA, the second AoA error, the second antenna orientation, the second position, the second position error, and/or the second ToA, associated with the second method in the FTM response.

14. The method of claim 13, wherein the initiating STA determines a second position of the initiating STA based on the FTM response.

15. The method of claim 13, wherein one of:
the controller determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA; or
the position server determines a second position of the initiating STA based on one or more of the AoA, the AoA error, the antenna orientation, the position, the position error, and/or the ToA, the second AoA, the second AoA error, the second antenna orientation, the second position, the second position error, and/or the second ToA.

16. A non-transitory information storage media having stored thereon one or more instructions, that when executed by one or more processors, cause an assisting station (STA) to perform a method, the method comprising:
receiving a Fine Time Measurement (FTM) request from an initiating station (STA);
generating a FTM response, the FTM response comprising one or more of an angle of approach (AoA), an AoA error, an antenna orientation, a position, and/or a position error;
sending a FTM response signal, including the FTM response, to the initiating STA.

17. The non-transitory information storage media of claim 16, wherein the method further comprises:
determining the AoA, the AoA error, the antenna orientation, the position, and/or the position error for the FTM request; and
determining a time of departure (ToD) and/or a time of arrival (ToA) for the FTM request, wherein the FTM response further comprises the ToD and/or the ToA.

18. The non-transitory information storage media of claim 17, wherein the method further comprises:
sending one or more of the AoA, the AoA error, the antenna orientation, the position, the position error, and/or the ToA to a position server;
receiving one or more of a second AoA, a second AoA error, a second antenna orientation, a second position, a second position error, and/or a second ToA, associated with a second method, from the position server; and
including the second AoA, the second AoA error, the second antenna orientation, the second position, the second position error, and/or the second ToA, associated with the second method in the FTM response.

19. The non-transitory information storage media of claim 18, wherein the initiating STA determines a second position of the initiating STA based on the FTM response.

20. The non-transitory information storage media of claim 18, wherein the method further comprises one of:
determining a second position of the initiating STA based on one or more of the AoA, the AoA error, the antenna orientation, the position, the position error, and/or the ToA, the second AoA, the second AoA error, the second antenna orientation, the second position, the second position error, and/or the second ToA; or
receiving, from the position server, the second position, wherein the position server determines the second position of the initiating STA based on one or more of the AoA, the AoA error, the antenna orientation, the position, the position error, and/or the ToA, the second AoA, the second AoA error, the second antenna orientation, the second position, the second position error, and/or the second ToA.
